(19) United States
(12) Patent Application Publication
(10) Pub. No.: US 2010/0085741 A1
(43) Pub. Date: Apr. 8, 2010

(54) BULB-BASED LIGHT STICK WITH SPRING ACTIVATION

(75) Inventor: Daniel Segel, Schenectady, NY (US)

Correspondence Address: Keohane & D'Alessandro, 1881 Western Avenue, Suite 180, Albany, NY, 12203, US

(73) Assignee: Daniel Segel, Schenectady, NY (US)

(21) Appl. No.: 12/574,747

(22) Filed: Oct. 7, 2009

Related U.S. Application Data
(60) Provisional application No. 61/103,393, filed on Oct. 7, 2008.

(51) Int. Cl. F21L 4/00

(52) U.S. Cl. 362/157

(57) ABSTRACT

The present invention generally relates to a bulb-based light stick comprising a vessel that contains an ampule of electrically conductive material (e.g., saline). The base of the vessel contains a circuit assembly that includes at least one battery, electrical contacts, and a light source such as a LED. When the ampule is broken in accordance with known light stick methods, the electrically conductive material fills the vessel and connects a set of electrical contacts. The result is to activate the LED, which illuminates the vessel. As such, the LED can be any color desired.

### CROSS-REFERENCE TO RELATED APPLICATION

This application is related to and claims the benefit of commonly owned and co-pending provisional application Ser. No. 61/103,393, filed Oct. 7, 2008. This application is also related to in some aspects to commonly owned and co-pending application Ser. No. 12/573,094, entitled Bulb-based Light Stick, which was filed on Oct. 3, 2009, the entire contents of which are herein incorporated by reference.

### FIELD OF THE INVENTION

This invention generally relates to light sticks. Specifically, this invention relates a bulb-based light stick.

### BACKGROUND OF THE INVENTION

Illuminating structures are well known. These structures have been used to add interest to children's toys and jewelry, create items for temporary lighting, and even as fishing lures. The use of chemiluminescent chemicals is one common method of creating an illuminating structure and is well known in the art. In these devices, a semi-translucent tube contains two chemicals. The mixture of the two chemicals creates a temporary lighting effect. To prevent the chemicals from mixing prematurely, the tube is filled with one of the chemicals, and ampules (frequently glass or plastic) that contain the second chemical are inserted into the tube. A user can then break the ampule to allow the chemicals to mix, generating the luminescent effect. Depending on the chemicals used, color of the tube, etc. different colors can be created. Various combinations of chemicals can be used to obtain a desired color and are discussed, for example, in U.S. Pat. No. 4,061,910 issued on Dec. 6, 1977. Unfortunately, chemicals only pose environmental and safety problems, but also longevity problems. As such, a need for an alternative exists.

### SUMMARY OF THE INVENTION

In general, the present invention generally relates to a bulb-based light stick comprising a vessel that contains an ampule of electrically conductive material (e.g., saline). The base of the vessel contains a circuit assembly that includes at least one battery, electrical contacts, and a light source such as a LED. When the ampule is broken in accordance with known light stick methods, the electrically conductive material fills the vessel and connects a set of electrical contacts. The result is to activate the LED, which illuminates the vessel. As such, the LED can be any color desired.

### BRIEF DESCRIPTION OF THE DRAWINGS

These and other features of this invention will be more readily understood from the following detailed description of the various aspects of the invention taken in conjunction with the accompanying drawings in which:

FIG. 1 shows bulb-based light stick according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DESCRIPTION OF THE INVENTION

The present invention generally relates to a bulb-based light stick comprising a vessel that contains an ampule of electrically conductive material (e.g., saline). The base of the vessel contains a circuit assembly that includes at least one battery, electrical contacts, and a light source such as a LED. When the ampule is broken in accordance with known light stick methods, the electrically conductive material fills the vessel and connects a set of electrical contacts. The result is to activate the LED, which illuminates the vessel. As such, the LED can be any color desired.

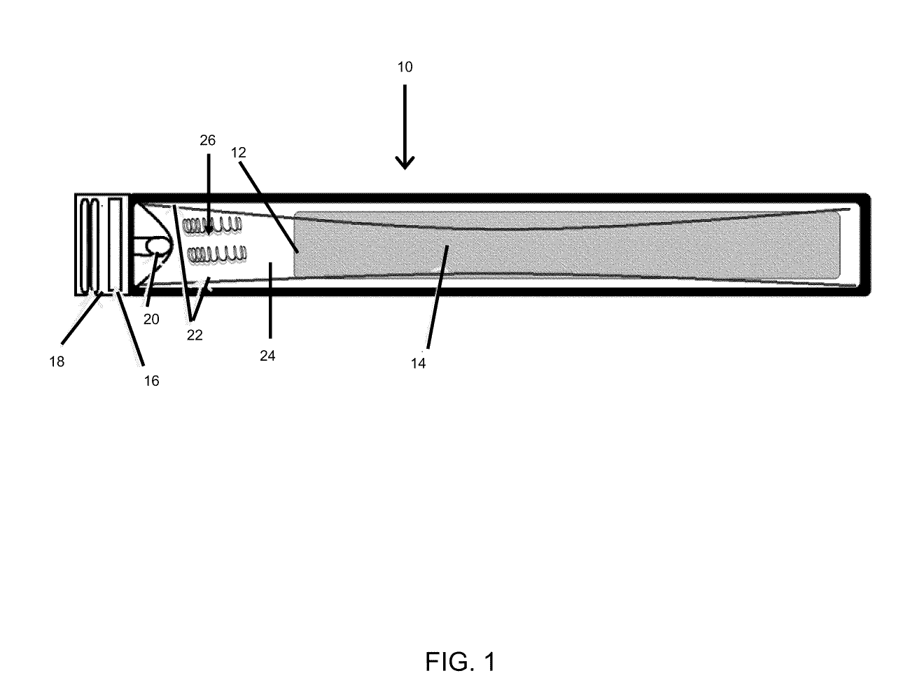

Referring now to FIG. 1, an illustrative device according to the present invention is shown. As mentioned above, the device comprises a vessel 10 containing an ampule 12 that (in one embodiment) is filled with electrically conductive material 14(e.g., a liquid). When ampule 12 is broken, the electrically conductive material 14 contacts/connects the electrical contacts 22, which engages the battery 18 powered circuit assembly 16. The result is that the light source/bulb 20 (e.g., an LED) will turn on and illuminate the light stick. The color can be based on the color of the light source 20 and/or the color of the material 14 in the ampule 12. If it is desired to turn off the light stick, the vessel 10 can be turned upside down so that the circuit assembly 16 is facing upwards. This can cause the liquid to fall out of contact with the electrical contacts 22 and thus, turn off the LED and conserving the battery 18.

The inside of the vessel becomes a mixing chamber 24 when the ampule is broken. In general, the mixing chamber 24 contains a minimum of two sensors, probes, contacts or wires that will allow the device to be activated when ampule contents are released. Depending on the configuration it may be possible to turn the device off if positioned in a way to break the circuit that causes activation. The sensors/contacts 22 are typically made of a material, preferably of metal that have conductive properties. The Integrated Circuit/assembly 16 or processor can contain any type of circuit, each for a specific function, such as sensing the circuit then activating a light source 20, the circuit assembly 16 is also capable of causing the light source 20 to change color, blink or flash, or just stay constantly lit. The circuit assembly 16 receives power from a set (e.g., one or more) of batteries 18 which are preferably lithium, and can be arranged either in series or in parallel depending on the needs of the circuit 16. The device is ideal for safety devices, LED based light sticks as it can be designed to be made waterproof and can be used under extreme conditions. It can also be incorporated into any electronic device as a method of guaranteed activation to prevent accidental activation, even products that do not use or contain a light source 20 such as a transponder or transceiver.

It should be understood that ampule 12 can contain any material 14 (solid liquid or gas) that is electrically conductive. In addition, circuit assembly 16 can be any known type of circuit assembly 16 that is capable of turning on a light source 20 such as a LED. Still yet, the light source 20 utilized need not be an LED, rather it could be any type of light source now known or later developed. These and other details/definitions, and/or alternatives are further given below:

Ampule 12—Primary purpose is to contain a substance 14 (saline, air, etc.) that is used to complete the circuit when released into the mixing chamber 24 when ampule 12 is broken.

Other Activation Methods—
(A) A magnetic device can be released when the vessel 10 is bent that will complete a circuit when connected. This magnetic device need not be contained in the ampule 12.
(B) Spring loaded mechanism 26 that is deployed to complete the circuit when the vessel 10 is bent. In this scenario, the ampule 12 can contain only or primarily air. Specifically, when the ampule 12 is broken, the set (e.g., one or more) of springs 26 can expand therefore causing the circuit to complete via a contact in the mixing chamber 24 that is not accessible when the set of springs 26 is taught (prior to breakage of the ampule 12).

An object such as a ball bearing (be-be) using g-forces and or pressure can be implemented to activate one of the above mentioned approaches. With this, an ice cube or other device can be created that is activated with a ball bearing.

I claim:

1. A bulb-based light stick comprising:
a vessel containing an ampule and a set of springs;
a circuit assembly connected to a light source, wherein the set of springs expand and causes the light source to Illuminate when the ampule is broken.

2. The bulb-based light stick of claim 1, the light source being a light emitting diode (LED).

3. The bulb-based light stick of claim 1, the circuit assembly comprising a set of electrical contacts that extends into the vessel, the set of contacts being placed in electrical contact with one another via the set of springs when the ampule is broken.
